(19) United States
(12) Patent Application Publication
(10) Pub. No.: US 2012/0198231 A1
(43) Pub. Date: Aug. 2, 2012

(54) SECURE COMMUNICATION DEVICE

(76) Inventor: Laurent Ryckelynck, Paris (FR)

(21) Appl. No.: 13/124,499

(22) PCT Filed: Oct. 15, 2009
(86) PCT No.: PCT/EP2009/063497

§ 371 Date: Apr. 15, 2011

(30) Foreign Application Priority Data
Oct. 15, 2008 (FR) 0856988

(51) Int. Cl. H04L 9/00; H04L 9/08

(52) U.S. Cl. 713/166

(57) ABSTRACT

The invention relates to a confidence core architecture that is more efficient in terms of design and evaluation than the usual architectures. The confidence core respects the partitioning principle of security recommendations, typically partitioning the red and black domains and the injection of keys. In this approach, the invention proposes the conversion of an existing single-interface component, namely an evaluated smart card component, into a multi-interface component that respects the partitioning principles. The component for carrying out the interface conversion is designed on a minimal, and if possible, an exclusively hardware basis that only implements the flow secure routing.

The present invention concerns the design of a hardware component dedicated to the security of a communication apparatus such as for example a mobile telephone.

Confidence core means the restricted portion of an item of equipment on which the security objectives assigned to this equipment are based for the purpose of security.

More and more items of equipment make it possible to access secure services such as for example banking services or access to secure professional services. These items of equipment must be secure and meet particularly strict standards with regard to security. In order to be able to be used during access to these services, these items of equipment must be approved by an authority and for this purpose undergo a certification procedure. This certification procedure checks that they do indeed meet a set of security criteria and can therefore be used to make the secure service function. Payment terminals and banking chip cards are examples of equipment subject to security certifications.

The confidence core is therefore the device implementing in the equipment communication between a so-called red domain and a so-called black domain. This device is a device for communication between two zones with different security levels. By convention, the red domain processes intelligible and sensitive information protected by its environment, and red information is also spoken of. The black domain represents the hostile environment that does not protect the information. In this domain, the information must be protected. A confidence architecture does not allow direct passages of information from the red domain to the black domain and vice versa.

Sensitive information is thus protected, in terms of confidentiality and/or integrity and/or authenticity, by passage thereof through the confidence core whose role it is. Conversely, the protected information coming from the black domain is made intelligible and/or verified and/or authenticated after having passed through the confidence core.

The security certification of the apparatus amounts to certifying the confidence core. If the latter meets the security standards, certification of the rest of the equipment is not necessary.

The mechanisms used to fulfil these functions of enciphering, deciphering, signature, signature verification, integrity calculation and integrity verification use cryptographic algorithms.

The robustness of the protection offered by the confidence core is obtained firstly by the mathematical complexity of the cryptographic algorithms that it integrates, and secondly by its ability to keep secret the keys or secret elements used by these cryptographic algorithms.

FIG. 1 illustrates the architecture of a confidence core according to the prior art. The confidence core 1.1 is composed of a processor 1.2 that is responsible for executing the confidence program. This processor communicates with a dedicated component 1.3 responsible for the cryptographic operations and inputs/outputs with the outside. This component is typically produced in the form of an ASIC (Application-Specific Integrated Circuit). This component 1.3 affords communication with the red domain 1.4 on the one hand and the black domain 1.5 on the other hand. A communication link 1.6 enables keys necessary to the functioning of the cryptographic component to be injected into it.

Certification of such a confidence core requires certification of all the functionalities of the core both with regard to the processor and the programs that it contains and with regard to the cryptographic component. Moreover, the design of such a confidence core is a lengthy, complex and expensive process.

The invention proposes a confidence core architecture that is more efficient in terms of design and in terms of evaluation than the usual architectures. It is a case of combining two simple design and evaluation components in order to obtain a confidence core that can be evaluated simply. This confidence core complies with the partitioning principles of the security recommendations, typically partitioning between the red and black domains and the injection of the keys. In this approach, the invention proposes to convert an existing single-interface component, namely an evaluated chip card component, into a multi-interface component that complies with the partitioning principles. The component implementing this interface conversion is designed on a minimal and if possible exclusively hardware basis that implements only the secure routing of flows.

The invention reduces the design cost by a significant factor. This is because the basis of the confidence core consisting of a chip card component exists and the supplementary switching function is reduced to the minimum. The innovation makes it possible in an induced manner also to reduce the cost of an evaluation by a significant factor, the chip card component being already evaluated, and the evaluation scheme is mastered. Moreover, the switching function, through its minimalist design, is also able to be evaluated simply. The combination of the designs and evaluations is then more effective than the design and evaluation of a monolithic component.

The invention also concerns a device for secure communication between two zones with different security levels that comprises a chip card component that guarantees confidentiality of the information and the use of cryptographic algorithms without leakage of information and a switching component affording alternately communication between the chip card component and each of the two zones with different security levels, and the introduction of cryptographic keys into the chip card component.

According to a particular embodiment of the invention, the switching component comprises three channels each having a switch so that, when one of the switches is closed, the other two are necessarily open.

According to a particular embodiment of the invention, each of the channels also comprises a protocol adaptation module enabling optional conversion of protocol if necessary between the external interface and the chip card component.

The features of the invention mentioned above, as well as others, will emerge more clearly from a reading of the following description of an example embodiment, the said description being given in relation to the accompanying drawings, among which:

FIG. 1 illustrates the architecture of a confidence core according to the prior art;

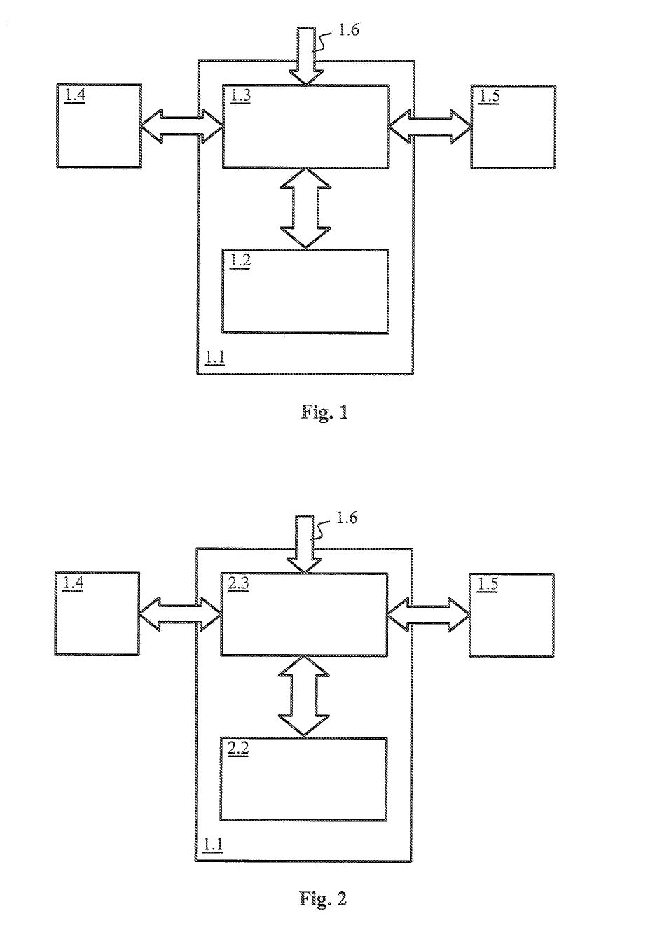

FIG. 2 illustrates the architecture of a confidence core according to the invention;

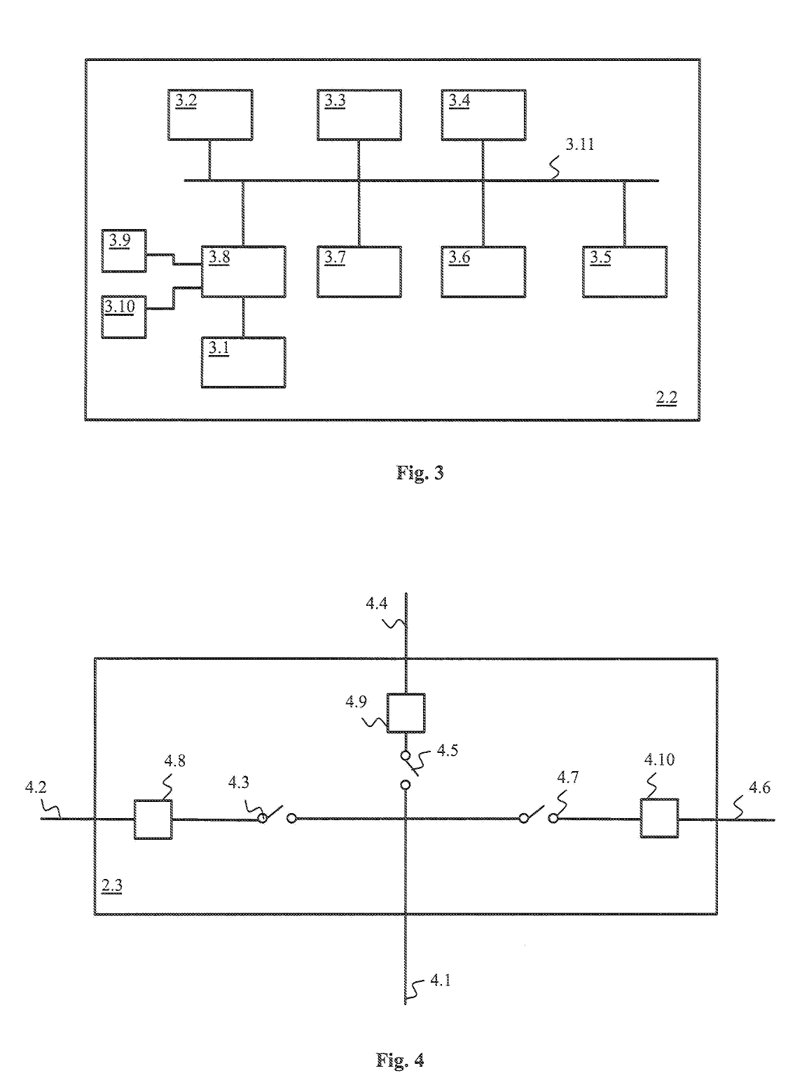

FIG. 3 illustrates the architecture of an example of a chip card component used in the invention;

FIG. 4 illustrates the architecture of an example embodiment of the switching component.

FIG. 2 illustrates the architecture of a confidence core according to the invention. It is architecture around a conventional chip card component 2.2. This component is a microcontroller resisting physical attacks, protected against reverse engineering and against the introduction of errors by particle clusters. It guarantees confidentiality of the information and the use of cryptographic algorithms without leakage of information. The chip card component already possesses the security objectives that it is wished to obtain from the confidence core. A chip card component, that it is to say the physical component and the software that it contains, affords a response to the normal objectives of information protection equipment: secure keeping of secret elements, enciphering, deciphering, control of access to the resource, etc. It is a good example of an evaluated peripheral security resource.

To implement the confidence core, it is necessary to give this component a switching component that makes it possible to implement the data paths to the red zone and the black zone and the introduction of cryptographic keys. This switching component affords alternately communication between the chip card component and each of the two zones with different security levels, as well as the introduction of cryptographic keys into the chip card component.

This is the role of the component 2.3. It establishes a secure unidirectional path between the chip card component and either the red zone or the black zone or the keys. This component is designed so that, at a given instant, only one of the paths can be active.

The device is designed so that the path by means of which the keys are introduced into the chip card component is unique. It thus ensures that no leakage of information can take place both during introduction and during the remainder of the use of the confidence core.

The advantage of this design is that the chip card component is already certified. To certify the confidence core according to the invention, it would therefore suffice to certify the switching component 2.3.

FIG. 3 illustrates the typical architecture of a chip card component 2.2 that can be used in the invention. Connected to the communication bus 3.11, a processor 3.8 is found. This processor is directly connected to a clock circuit 3.9 and to a reset management component (Reset Logic) 3.10, and to a security circuit 3.1. A module managing the inputs/outputs 3.7 affords communication with the outside and in this case with the switching component. A module 3.6 enables random numbers used in the cryptographic algorithms to be generated. A dedicated cryptographic calculation module 3.5 fulfils the cryptographic functions. The memory is broken down into a first E2PROM (Electrically Erasable Programmable Read-Only Memory) module 3.4 that contains the data and the embedded software, a second RAM (Random Access Memory) module 3.3 that contains the date and program temporarily during execution thereof, and a third ROM (Read Only Memory) or FLASH memory module 3.2 that also contains chip card dedicated embedded software.

FIG. 4 illustrates the architecture of the switching component 2.3. This component comprises a link 4.1 serving to communicate with the chip card core. This link affords communication with three input/output channels 4.2, 4.4 and 4.6 via three switch mechanisms for closing or opening each channel 4.3, 4.5 and 4.7. Each of the channels is advantageously provided with an adaptation module 4.8, 4.9 and 4.10 allowing any protocol conversion if necessary between the external interface and the chip card component.

The links are bidirectional and are typically interfaces of the serial type capable of being converted very simply in a protocol managed by a chip card component, the ISO 7816-3 protocol.

The component is designed so that, when a switch is conducting, the others are necessarily open in order to provide the partitioning sought. No data transmission can take place between the different interfaces 4.2, 4.4 and 4.6 without passing through the chip card component, which therefore ensures security of the device. This switching component is in the end the only component requiring security certification that remains simple because of the simplicity of design of this component.

1. Device for secure communication between two zones with different security levels, characterised in that it comprises:
an evaluated peripheral security resource, such as a chip card component, which guarantees confidentiality of the information and the use of cryptographic algorithms without leakage of information;
a switching component affording communication alternately between the chip card component, each of the two zones With different security levels and the path enabling cryptographic keys to be introduced into the chip card component.

2. Device according to claim 1, characterised in that the switching component comprises three channels each having a switch so that, when one of the switches is closed, the other two are necessarily open.

3. Device according to claim 2, characterised in that each of the channels also comprises a protocol adaptation module allowing any protocol conversion if necessary between the external interface and the chip card component.
